(19) United States
(12) Patent Application Publication
(10) Pub. No.: US 2020/0137965 A1
(43) Pub. Date: May 7, 2020

(54) Steam Shank Rotor Assembly

(71) Applicant: William L. Register, Plant City, FL (US)

(72) Inventor: William L. Register, Plant City, FL (US)

(21) Appl. No.: 16/663,545

(22) Filed: Oct. 25, 2019

Related U.S. Application Data
(60) Provisional application No. 62/754,002, filed on Nov. 1, 2018.

(51) Int. Cl. A01G 11/00; A01B 49/04; A01B 33/02

(52) U.S. Cl. CPC A01G 11/00; A01B 77/00; A01B 33/021; A01B 49/04

(57) ABSTRACT

A steam shank rotor assembly having rigid teeth connected to a hollow shaft via teeth mounts which collectively allow steam to circulate from the hollow shaft to the nozzles located near the working end of the teeth, and then into the soil. This invention provides an agricultural apparatus that simultaneously tills and disinfects soil with the use of steam.

### CROSS-REFERENCE TO RELATED APPLICATIONS

This application claims priority to pending provisional application No. 62/754,002, filed Nov. 1, 2018, the disclosure of which is incorporated by reference herein.

### BACKGROUND OF THE INVENTION

### Field of the Invention

This invention relates to an agricultural tilling apparatus. Specifically, this invention relates to an apparatus that removably connects to a tractor-like machine and includes that ability to have steam circulated throughout itself to disinfect the soil while simultaneously tilling the soil.

### Description of the Background Art

Presently there exists technology for disinfecting soil by several different methods. Sheet steaming is a method where a large amount of soil has a large perforated sheet placed over it, whereby steam is introduced throughout the sheet, which is then effectively leaked onto the large pile of soil. The shortcomings of sheet steaming include the fact that it is a separate process from that of tilling. Once the soil is tilled, the user must then place the sheet over the soil for disinfecting. Thus, this method requires a considerable amount of labor and time.

Another method includes sandwich steaming. Sandwich steaming is a process whereby a large apparatus disinfects soil by injecting steam into the soil. The large apparatus can be viewed as a square-like metal sheet with many needle-like extensions protruding from its bottom surface. The needle-like extensions are hollow to allow steam to flow through into the soil. The shortcomings are apparent in that the apparatus must cover a large amount of area to be effective, thus requiring a large amount of metal materials. Furthermore, the structure is not designed to till the soil, thus the tilling process would be an additional task to be completed.

Therefore, it is an object of this invention to provide an improvement, which overcomes the aforementioned inadequacies of the prior art devices and provides an improvement, which is a significant contribution to the advancement of the steam shank rotor assemblies.

Another object of this invention is to provide an agricultural apparatus that simultaneously tills and disinfects soil with the use of steam.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

Embodiments of the present invention are herein described by way of example and directed to a steam shank rotor assembly. The aforementioned state of the art of steam shank rotor assemblies shows the need for improvements, specifically in the field of simultaneously tilling and disinfecting soil.

For the purpose of summarizing this invention, this invention comprises an apparatus that has rigid teeth connected to a hollow shaft via teeth mounts, which are connected to the hollow shaft via welding. The teeth are arranged on the hollow shaft such that they are uniformly staggered along the hollow shaft. Each tooth has an interior fluid passageway, which connects to the hollow shafts fluid passageways. These fluid passageways allow the steam to be transferred from the hollow shaft to the teeth and injected into the soil via the nozzles.

The hollow shaft is rotated by a transmission, which gathers its input via a power take off from a tractor or similar conveyance and therefore may be employed an attachment to a multitude of farming machinery and thus, is designed for that purpose, similar to many types of equipment that are either placed in the front of or behind a tractor or tractor-like machine.

The operable temperature of the soil may range considerably depending on the application, such as eliminating bugs compared to destroying weeds. For eliminating bugs, the preferable temperature of the soil would need to reach 75-80° C. for a time longer than instantaneous and may last until the soil is saturated with water from the repeated application of steam.

The unique design of the steam shank rotor assembly of the present invention satisfies the aforementioned deficiencies of the prior art because it takes advantage of a hollow shaft and components that allow steam to circulate from the steam canister all the way to the nozzles located the working end of each tooth and then into the designated soil as the soil is tilled by the rotation of the rotating teeth.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the steam shank rotor assembly in accordance with the underlying principles of the present invention;

FIG. 2 is a front plan view of the steam shank rotor assembly thereof;

FIG. 3 is an enlarged view of FIG. 1 thereof;

FIG. 4 is an enlarged view of FIG. 2 thereof;

FIG. 5 is a left plan view of the present invention thereof;

FIG. 6 is a perspective view of both the tooth and tooth mount thereof;

FIG. 7 is an exploded view of FIG. 1 thereof;

FIG. 8 is an enlarged view of the hollow shaft thereof;

FIG. 9 is a cross sectional view of the tooth mount thereof;

FIG. 10 is a rear elevational view of the tooth mount thereof;

FIG. 11 is a cross sectional view of the tooth thereof;

FIG. 12 is a view of the tooth thereof;

FIG. 13 is a rear elevational view of the tooth thereof;

FIG. 14 is a front plan view of an apparatus used in conjunction with the steam shank rotor assembly of the present invention;

FIG. 15 is a perspective view of the apparatus used in conjunction with the present invention; and

FIG. 16 is a front plan view of the apparatus used in conjunction with the present invention.

Similar reference characters refer to similar parts throughout the several views of the drawings.

### DETAILED DESCRIPTION OF THE PREFERRED EMBODIMENT

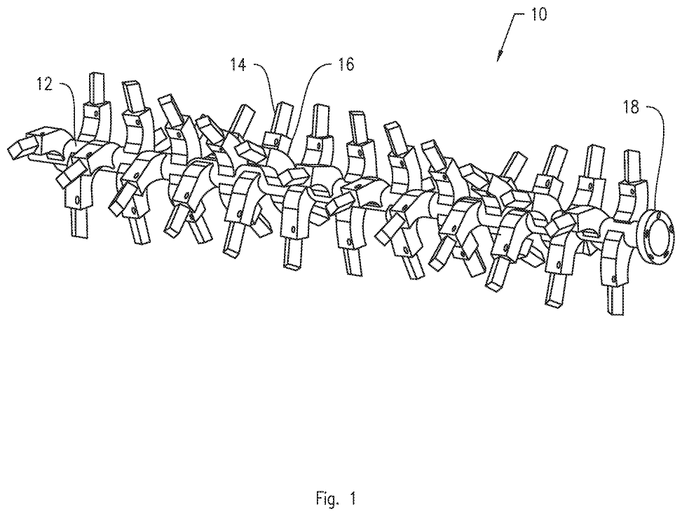

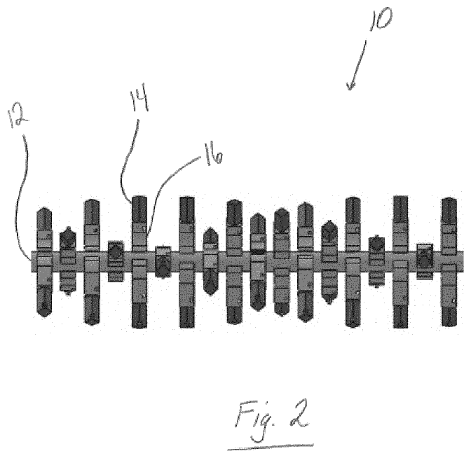

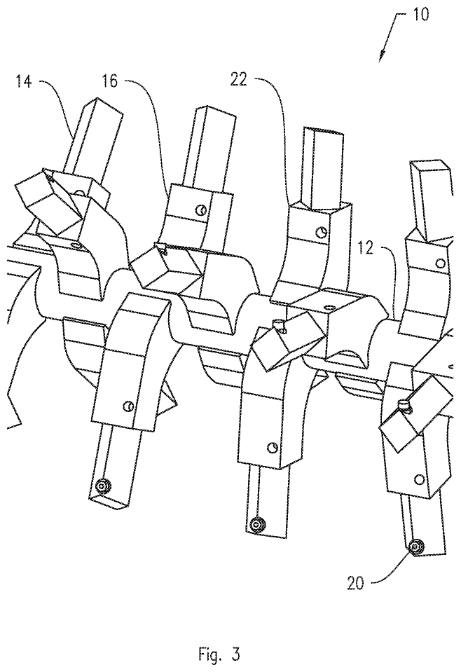

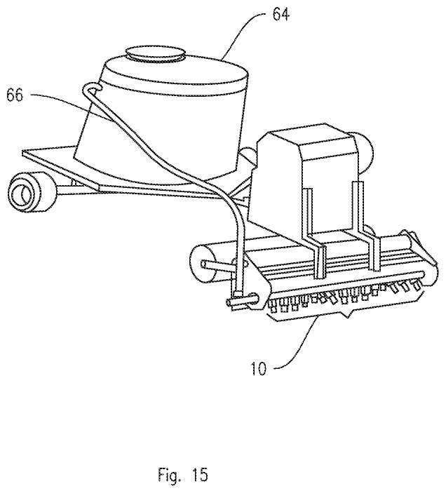

As shown in FIGS. 1-4, the steam shank rotor assembly 10 has a hollow shaft 12 that includes multiple teeth mounts 16 protruding radially in a staggered pattern along the lateral surface of the hollow shaft 12. The hollow shaft 12 further includes a flange 18 that connects the hollow shaft 12 to a gear box 62 as shown in FIG. 14. The gear box 62 contains a transmission that receives a power input via a power take off 44. The power take off 44 is further connected to a tractor or tractor-like machine.

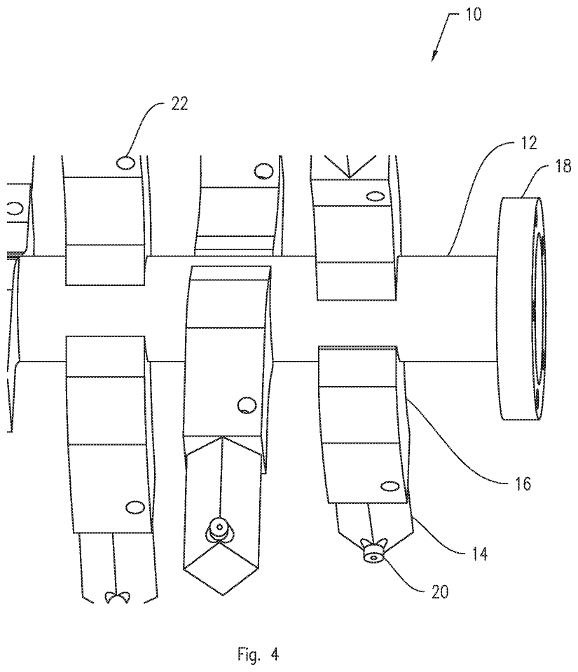

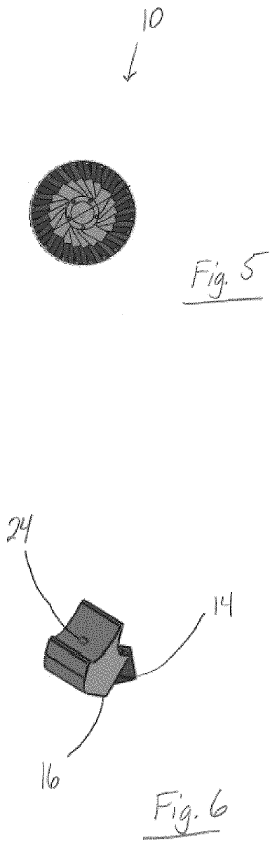

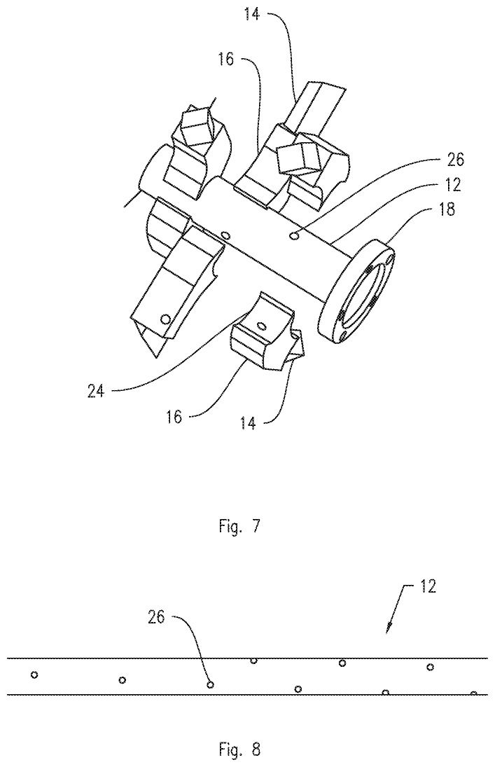

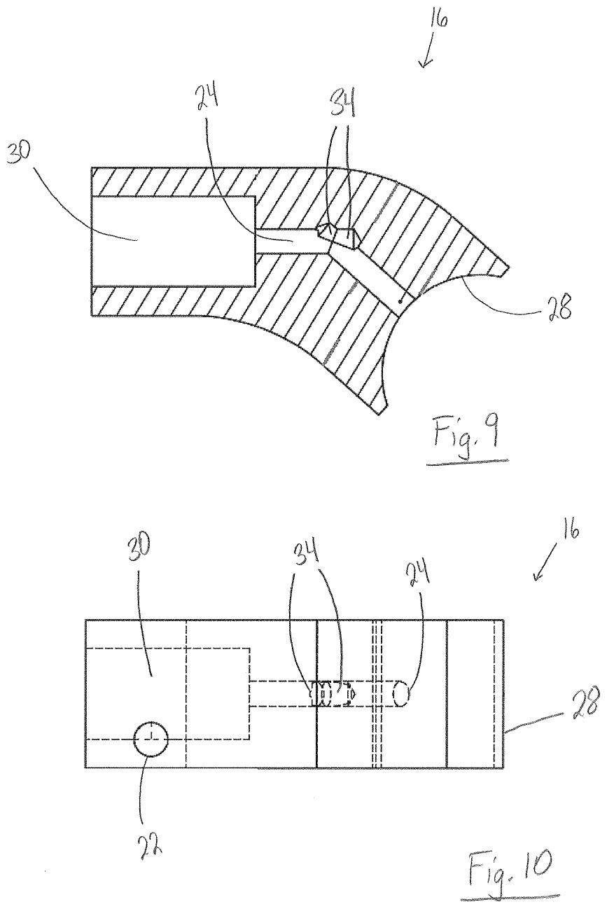

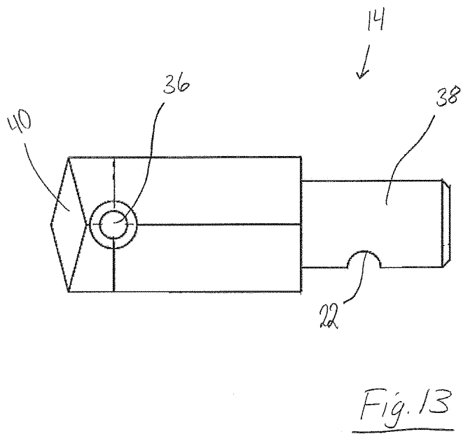

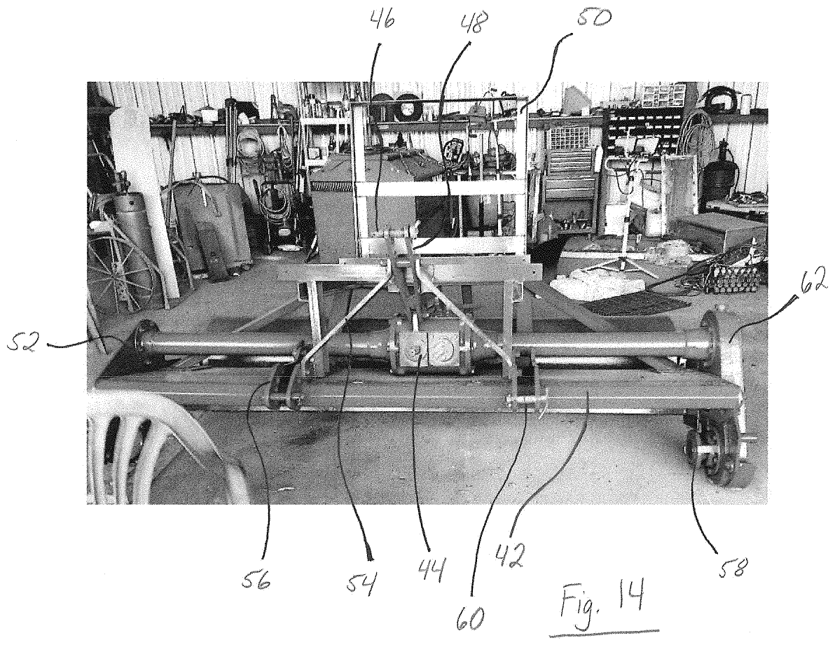

The teeth 14 of the hollow shaft 12 are connected to their corresponding teeth mounts 16 via set screw holes 22. The teeth 14 each have corresponding nozzle receptacles 36 (FIGS. 11-13) wherein nozzles 20 are housed as shown in FIG. 4.

As shown in FIG. 5, when looking down along the lateral axis of the hollow shaft 12, the sum of the teeth 14 and teeth mounts 16 are viewed as creating a larger circumference compared to that of the circumference of the hollow shaft 12. Thus, each tooth 14 and tooth mount 16 are arranged such that they create staggered positions along the hollow shaft 12, which can be seen as a uniform, albeit staggered, pattern of material.

As shown in FIG. 6, the tooth mount 16 includes a tooth mount fluid passageway 24 that interfaces with a hollow shaft fluid passageway 24 via a welding interface 28 as shown in FIG. 9. The tooth mount 16 has a lower end that is formed as an arc to be operably welded onto the hollow shaft 12, which is itself a cylindrical pipe. Thus, each tooth mount 16 is designed to attach to a cylindrical object. Notably, the pipe may have different geometries, such as a square pipe, and thus, the teeth mounts 16 would be designed accordingly. The welding interface can be seen in FIG. 7.

As shown in FIG. 8, the hollow shaft 12 has hollow shaft fluid passageways 26 that connect via the welding interface 28 to the tooth mounts 16. The welding includes conventional welding techniques, but may further include any connecting means such as adhesives, straps, etc.

As shown in FIG. 9, each tooth mount 16 has a tooth receptacle 30 that receives each tooth 14. Each tooth 14 has a corresponding tooth fluid passageway 32 that comes into contact with the corresponding tooth mount fluid passageway 24. The tooth mount 16 further includes a welding interface 28. Drill bit excavations 34 are also shown which represent the volume removed by the use of a drill bit to create the tooth fluid passageways 32. Notably, any other method may be used to create these tooth fluid passageways 32. For example, if a less rigid material was used for the teeth 14 and teeth mounts 16, a less formidable method could be used to create the fluid passageways 32, such as using a punch press.

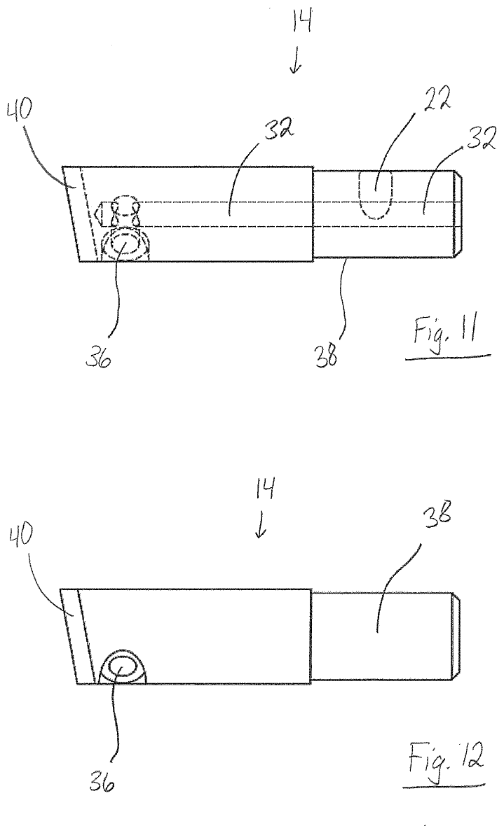

As shown in FIG. 10, each tooth mount 16 includes a set screw hole 22 for the purpose of connecting to the corresponding teeth 14 and further, to be removable for cleaning and repairs. Any other method or techniques may be used to connect the tooth 14 to the tooth mount 16, such as adhesives.

As shown in FIGS. 11-13, each tooth 14 has a nozzle receptacle 36 that houses a nozzle 20, whereby the steam exits the apparatus and transfers into the soil. Each tooth 14 further includes a tooth fluid passageway 32 that extends from its working end 40 to the base of its male end 38. The tooth fluid passageway 32 is in fluid contact with the fluid passageway of the tooth mount 24. Each tooth 14 is connected to its corresponding tooth mount 16 via a set screw placed into a set screw hole 22.

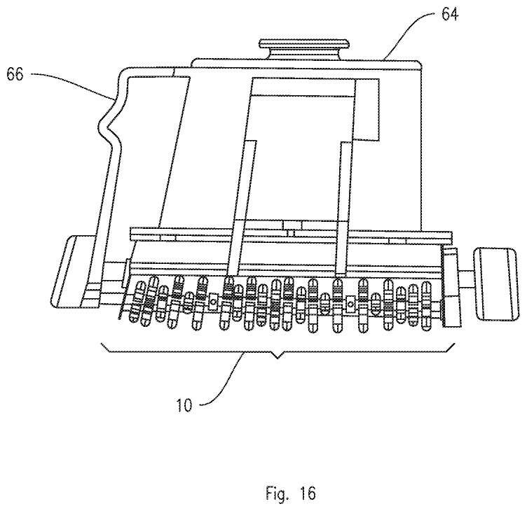

As shown in FIGS. 14, 15 and 16, the steam shank rotor assembly 10 can be fitted to be used with standard agricultural equipment typically employed for uses such as tilling. The rotor 10 is attached via a flange connection 58 to a gear box 62 that is provided power via a power take-off 44. The system shown in FIGS. 14, 15 and 16 has a clevis-styled attachment 48 that attaches the system to a tractor-styled vehicle via a clevis pin 46. The clevis-styled attachment 48 includes a plurality of arms, or A-frames 54 for support. The A-frame 54 is further attached to multiple ears 56 for support and adjustability. A boiler 64 is mounted to the system and provides steam to the steam shank rotor assembly 10 via a steam hose 66. The steam hose 66 may be attached to a side member 52 for additional support while simultaneously being fluidly connected to the hollow shaft 12. The steam tank is connected to a canister bracket 50, allowing the tank to be positioned on the standard agricultural equipment while in use.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A steam shank rotor to be operatively connected to a piece of farming equipment comprising:
a hollow shaft operatively connected to the piece of farming equipment to cause said hollow shaft to rotate;
at least one tooth mount fluidly connected to said hollow shaft, said tooth mount being rigidly connected to said hollow shaft to rotate about the rotational axis of said hollow shaft upon rotation of said hollow shaft;
a tooth including a tooth fluid passageway fluidly connected to said tooth mount, said tooth being rigidly connected to said tooth mount;
a nozzle fluidly including a nozzle fluid passageway fluidly connected to said tooth, said nozzle being rigidly connected to said tooth,
whereby, upon injection of a fluid into said hollow shaft, the fluid is directed to flow through said hollow shaft, through said at least one tooth, through said tooth and out said nozzle.

2. The steam shank rotor of claim 1, wherein said at least one tooth further comprises a working end.

3. The steam shank rotor of claim 1, wherein said hollow shaft is operatively positioned parallel to a bed of soil.

4. The steam shank rotor of claim 1, wherein said tooth fluid passageway and tooth mount fluid passageway have equal diameters.

5. The steam shank rotor of claim 1, wherein said hollow shaft is operatively connected to a gear box.

6. A system of farming equipment used to sterilize and till soil, comprising in combination:
a hollow shaft operatively connected to the piece of farming equipment to cause said hollow shaft to rotate, at least one tooth mount fluidly connected to said hollow shaft, said tooth mount being rigidly connected to said hollow shaft to rotate about the rotational axis of said hollow shaft upon rotation of said hollow shaft, a tooth including a tooth fluid passageway fluidly connected to said tooth mount, said tooth being rigidly connected to said tooth mount, a nozzle fluidly including a nozzle fluid passageway fluidly connected to said tooth, said nozzle being rigidly connected to said tooth, whereby, upon injection of a fluid into said hollow shaft, said fluid is directed to flow through said hollow shaft, through said at least one tooth, through said tooth and out said nozzle.
said hollow shaft operatively connected to a steam hose; and
said steam hose further operatively connected to a boiler.

7. The system of claim 6, wherein said at least one tooth further comprises a working end.

8. The system of claim 6, wherein said hollow shaft is operatively positioned parallel to a piece of soil.

9. The system of claim 6, wherein said tooth fluid passageway and tooth mount fluid passageway have equal diameters.

10. The system of claim 6, wherein said hollow shaft is operatively connected to a gear box.

11. A method of sterilizing and tilling a piece of soil comprising the steps of:
positioning a steam shank rotor assembly comprising a hollow shaft operatively connected to the piece of farming equipment to cause said hollow shaft to rotate, at least one tooth mount fluidly connected to said hollow shaft, said tooth mount being rigidly connected to said hollow shaft to rotate about the rotational axis of said hollow shaft upon rotation of said hollow shaft, a tooth including a tooth fluid passageway fluidly connected to said tooth mount, said tooth being rigidly connected to said tooth mount, a nozzle fluidly including a nozzle fluid passageway fluidly connected to said tooth, said nozzle being rigidly connected to said tooth to extend into the piece of soil, said steam shank rotor, whereby, upon injection of a fluid into said hollow shaft, said fluid is directed to flow through said hollow shaft, through said at least one tooth, through said tooth and out said nozzle, said hollow shaft operatively connected to a steam hose, said steam hose further operatively connected to a boiler; and
operating the steam shank rotor by engaging the boiler, the boiler being operatively connected to a steam hose, the steam hose being operatively connected to the hollow shaft.

12. The method of claim 11, wherein the at least one tooth further comprises a working end.

13. The method of claim 11, wherein the hollow shaft is operatively positioned parallel to a piece of soil.

14. The method of claim 11, wherein the tooth fluid passageway and tooth mount fluid passageway have equal diameters.

15. The method of claim 11, wherein the hollow shaft is operatively connected to a gear box.
